(19) United States
(12) Patent Application Publication
(10) Pub. No.: US 2012/0087684 A1
(43) Pub. Date: Apr. 12, 2012

(54) IMAGE FORMING APPARATUS, TONER AMOUNT CALCULATION METHOD, AND STORAGE MEDIUM

(75) Inventor: Hidemi Sasaki, Kawasaki-shi (JP)

(73) Assignee: CANON KABUSHIKI KAISHA, Tokyo (JP)

(21) Appl. No.: 13/252,783

(22) Filed: Oct. 4, 2011

(30) Foreign Application Priority Data
Oct. 8, 2010 (JP) 2010-228382

(51) Int. Cl. G03G 15/08

(52) U.S. Cl. 399/53

(57) ABSTRACT

An apparatus and method for calculating toner amount including receiving print setting information, performing image processing on print data based on the print setting information received by the reception unit to form an image, calculating a print data feature quantity of the print data based on the formed image, and calculating a toner amount in a case where the print setting information is changed based on difference information between the print setting information before it is changed and after it is changed, and the calculated print data feature quantity based on the image formed by the image formation unit using the print setting information before it is changed.

### BACKGROUND OF THE INVENTION

1. Field of the Invention

The present invention relates to an image forming apparatus, a toner amount calculation method, and a storage medium.

2. Description of the Related Art

A known preview display apparatus has functions of calculating an amount of used toner based on print settings and displaying the amount, for example, as discussed in Japanese Patent Application Laid-Open No. 2006-343641. The known technique includes functions of, in outputting target print data, calculating a toner amount necessary for outputting the print data, and warning if the toner amount filled in the body is not enough.

Meanwhile, high responsivity is required for users to operate a preview screen without stress. However, in the known technique, if the print setting is changed, according to the changed print setting, an image is formed and the amount of the used toner is calculated again. In the image forming processing, according to the print setting specified by the user, various coordinate transformation and image processing are to be performed. The processing requires high calculation costs. Further, if a charge display function based on the toner amount, or the like is performed, the responsivity decreases.

### SUMMARY OF THE INVENTION

The present invention is directed to quickly calculating an amount of toner when a print setting is changed.

According to an aspect of the present invention, an image forming apparatus includes a processor coupled to a memory, the processor configured to control a receiving unit configured to receive print setting information, an image formation unit configured to perform image processing on print data based on the print setting information received by the receiving unit and to form an image, a print data feature quantity calculation unit configured to calculate a print data feature quantity of the print data based on the image formed by the image formation unit, and a first toner amount calculation unit configured to calculate a toner amount in a case where the print setting information is changed, based on difference information between the print setting information before it is changed and after it is changed, and the print data feature quantity calculated by the print data feature quantity calculation unit based on the image formed by the image formation unit using the print setting information before it is changed.

According to the present invention, when a print setting is changed, an amount of toner can be quickly calculated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a hardware configuration of an image forming apparatus.

FIG. 2A to FIG. 2C illustrate examples of a preview screen user interface (UI).

FIG. 3 is a block diagram illustrating an example of a module configuration of the image forming apparatus.

FIG. 4 illustrates a logic of toner amount calculation.

FIG. 5 is a flowchart illustrating an overall flow of displaying a preview image.

FIG. 6 (6A+6B) is a flowchart illustrating processing of calculating a print data feature quantity from a full-size image.

FIG. 7 is a flowchart illustrating processing of calculating a toner amount from a print data feature quantity.

FIG. 8 is a flowchart illustrating processing of calculating a charge from a toner amount.

FIG. 9 is a flowchart illustrating processing of determining whether second rasterization is to be performed due to a layout change.

FIG. 10 illustrates an example of an influence coefficient table used for calculating a toner amount same magnification variation if a print setting difference exists.

FIG. 11 is a flowchart illustrating processing of calculating a toner amount same magnification variation from a print setting difference.

FIG. 12 is a flowchart illustrating processing for calculating a toner amount from a print data feature quantity, a toner amount same magnification variation, and a magnification rate.

FIG. 13A to FIG. 13F illustrate examples of print data used in a first exemplary embodiment.

FIG. 14A to FIG. 14C illustrate calculation methods in a calculation example 1.

FIG. 15A to FIG. 15D illustrate calculation methods in a calculation example 2.

FIG. 16A to FIG. 16C illustrate calculation methods in a calculation example 3.

### DESCRIPTION OF THE EMBODIMENTS

Various exemplary embodiments, features, and aspects of the invention will be described in detail below with reference to the drawings.

First, a summary of exemplary embodiments described below is described. An image forming apparatus in each exemplary embodiment described below performs interpretation processing and rasterization processing on print data, and calculates a feature quantity of the print data (print data feature quantity).

If print setting information is changed, the image forming apparatus roughly calculates whether the toner amount (toner usage) varies based on difference information about the change in the print setting information, and the print data feature quantity. By the calculation, if the print setting is changed, the toner amount can be quickly calculated.

However, depending on the contents of the changed print setting information, or the like, since the calculation is roughly performed, the toner amount in the calculation result may be inaccurate. In such a case, if the print setting information change does not largely influence the output image, the image forming apparatus according to the exemplary embodiments described below calculates the toner amount using the difference information and the print data feature quantity.

On the other hand, if the print setting information change largely influences the output image, the image forming apparatus forms an image based on the changed print setting information, and based on the formed image, calculates the print data feature quantity of the print data. Further, the image forming apparatus calculates the toner amount based on the calculated print data feature quantity.

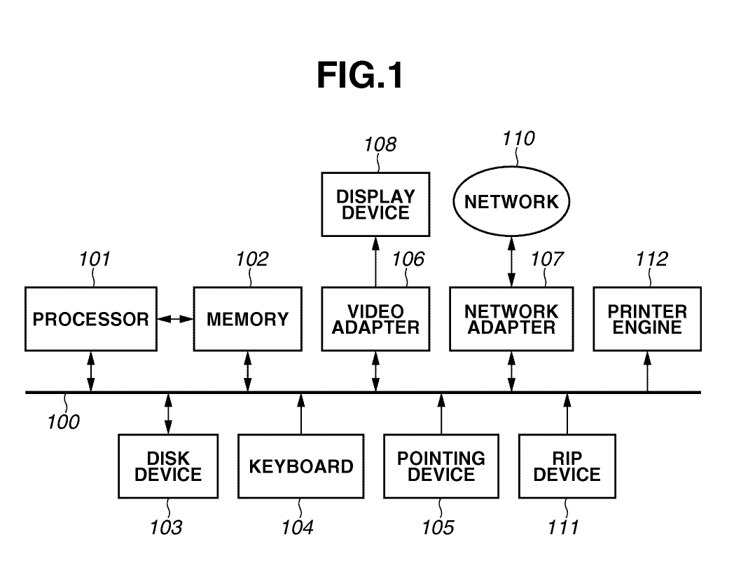

FIG. 1 is a block diagram illustrating an example of a hardware configuration of the image forming apparatus.

A processor 101 is connected via a bus 100 to a memory 102, a disk device 103, a keyboard 104, a pointing device 105, a video adapter 106, and a network adapter 107. Similarly, the processor 101 is also connected to a raster image processor (RIP) device 111 and a printer engine 112. To the video adapter 106, a display device 108 is connected.

The processor 101 controls each unit described above according to a processing procedure, that is, a predetermined program stored in the memory 102. The memory 102 stores the program and data used by the processor 101. The disk device 103 records a program and data necessary for the image forming apparatus. More than one disk device 103 may be connected. The disk device 103 can be a storage device such as a read-only memory (ROM) , a hard disk, a universal serial bus (USB) storage, a Secure Digital (SD) card, and a network storage.

The disk device 103 stores thresholds or the like described below. A user can enter information into the image forming apparatus using the keyboard 104 or the pointing device 105. The image forming apparatus can display various types of information on the display device 108 using the video adapter 106. The image forming apparatus can be connected to the network 110 via the network adapter 107.

A flow of processing in media direct print is described below. A user who wants to perform media direct print connects a storage device that serves as the disk device 103 such as a USB storage and an SD card to the image forming apparatus.

The user issues an instruction for displaying a menu screen for the media direct print on the image forming apparatus via the keyboard 104 or the pointing device 105. The processing can be performed by automatically detecting connection of the processor 101 and automatically displaying the menu screen for the media direct print.

The processor 101 displays a list of files stored in the disk device 103 on the display device 108. The user selects a file to be processed from the file list displayed on the display device 108 using the keyboard 104 or the pointing device 105. In response to the selection of the file, the image forming apparatus regards the operation as a preview display instruction, and displays a preview display screen on the display device 108.

In response to a print instruction or a preview display instruction by the user, the processor 101 implements a program of the procedure described below, which is stored in the memory 102. By the processing, the print data is interpreted. According to the interpreted result, the RIP device 111 forms an image. In a case where the print instruction is issued, the printer engine 112 prints the formed image on physical paper. In a case where the preview display instruction is issued, the formed image is displayed on the display device 108.

The processor 101 acquires information of the file name specified by the user from the print instruction, and reads the file as the print data from the disk device 103. The processor 101 determines a page description language (PDL) for processing the described data from a feature of at least one of the contents of the file and the file name.

According to the syntax of the determined PDL, the processor 101 implements interpretation processing of the file, page generation processing according to the interpretation processing, rendering processing, page end processing, or the like. The page generation processing is performed to make a region for storing a display list generated in the rendering processing, which is described below, in the memory 102. In the processing, other initialization processes implemented in starting the page are also performed.

The rendering processing is performed to interpret the rendering command described in the file, and convert the command into a display list that can be interpreted by the RIP device 111. The display list includes a specification of a color or a tile pattern to paint, a specification of a region for rendering, and a specification of a region for clipping. In the page end processing, the processing at a logical page currently being processed means the end. The page end processing is performed to release a resource that is not used anymore, or the like.

The processor 101 notifies the RIP device 111 of the display list. The RIP device 111 forms an image based on the display list, and stores the formed image in the memory 102.

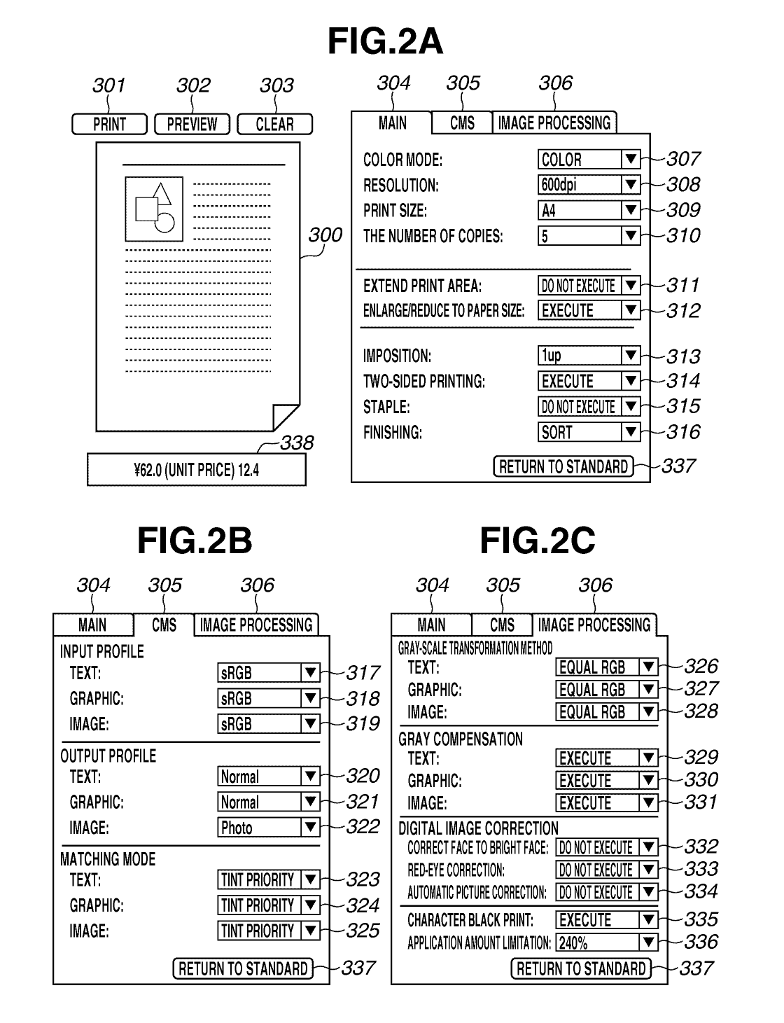

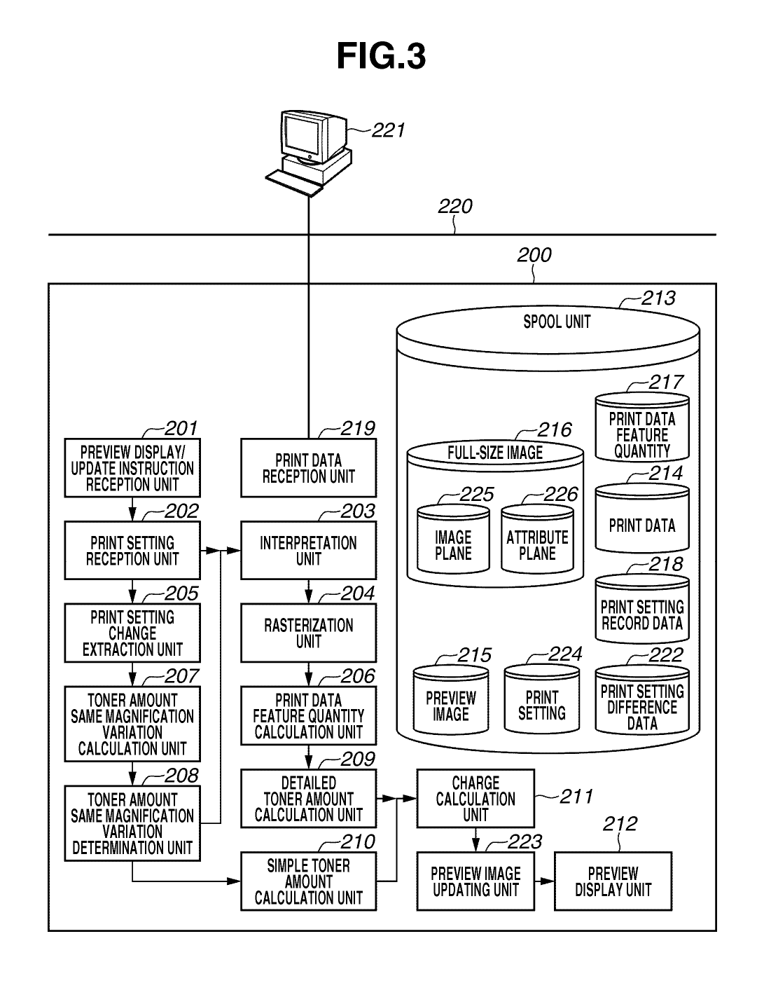

A first exemplary embodiment is described with reference to FIGS. 2 and 3.

### <Print Setting UI>

First, referring to FIGS. 2A to 2C, examples of preview screen UI displayed on the display device 108 by a preview display unit 212 in a case where the present invention is appropriately applied are described.

A preview display image 300 is for displaying a preview image formed based on print data. A print button 301 is used to issue an instruction for printing the print data on physical paper by the printer engine 112 based on print settings that can be set by various print settings 307 to 336, which will be described below.

A preview button 302 is used to issue an instruction for displaying the print data on a screen by the display device 108 based on the print settings that can be set by various print settings 307 to 333, which will be described below. A clear button 303 is used to change the print settings that can be set by the print settings 307 to 333, which will be described below, to default settings of the apparatus.

A main tab 304 is a tab button used to display print settings frequently used mainly in printing. A CMS tab 305 is a tab button used to display print settings relating to color matching processing used in printing. An image processing tab 306 is a tab button used to display print settings used in other image processing.

If the main tab 304 is selected, FIG. 2A is displayed. If the CMS tab is selected, on the left side, the preview display screen 300 on the left side in FIG. 2A and the buttons 301 to 303, and on the right side, FIG. 2B are displayed. Similarly, if the image processing tab is selected, on the left side, the preview display screen 300 on the left side in FIG. 2A and the buttons 301 to 303, and on the right side, FIG. 2C are displayed. The contents on the left side are similar to each other if any one of the tabs is selected. Accordingly, the contents are omitted as a common part.

The following processing is implemented by the processor 101 that serves as a part of an interpretation unit 203. A color mode setting 307 is for selecting a color space for outputting the print data. In the setting, “color” or “monochrome” can be set.

A resolution setting 308 is for setting a resolution of an image formed in a rasterization unit 204 in outputting the print data. In the resolution setting 308, “600 dpi” or “1200 dpi” can be selected.

A print size setting 309 is for selecting a size of physical paper to be output. In the print size setting 309, a size within sheet sizes supported by the printer engine 112 can be selected. If “automatic” is selected, the processor 101 determines the physical paper size to be output using sheet size information included in print data 214.

A number of copies setting 310 is for selecting the number of copies of the physical paper to be output. A print area extension specification 311 is a specification for performing image formation and printing by ignoring an engine margin part on the physical paper to be output. If “do not execute” is selected in the print area extension specification 311, a few millimeters from an end part of the physical paper is determined to be a margin, and the printing is not performed on the area. If “execute” is selected, the entire physical paper is the target of the printing, however, on a part where the printing cannot be performed due to limitations of the engine, the printing is not performed.

An enlargement/reduction setting 312 of paper size is for selecting whether to enlarge or reduce an object in the print data 214 to the print size set in the print size setting 309 and outputting the data. In the setting, if “execute” is selected, image formation is performed to fit to the size of the physical paper to be output by an appropriate magnification rate or a reduction rate.

In the processing, the aspect ratio of the object in the print data is maintained. In the print size setting 309, if “automatic” is selected, the setting is invalidated, and the output image is not influenced.

An imposition setting 313 is for imposing a logical page in the print data on the physical paper to be output set in the print size setting 309. In the imposition setting 313, “1up”, “2up”, “4up”, “6up”, “8up”, “9up”, or “16up” can be set, respectively.

The physical paper is divided according to the number of the imposition respectively, and the logical page in the print data is enlarged or reduced while the aspect ratio is maintained. In the print size setting 309, if “automatic” is selected, the setting is invalidated.

A two-sided printing setting 314 is for selecting whether the printing is to be performed on only one side or on two sides of the physical paper to be output. If “execute” is selected, the printer engine 112 tries to perform the printing on both sides. If “do not execute” is selected, the printer engine 112 tries to perform the printing on only one side.

A staple setting 315 is for selecting whether to perform stapling to the physical paper to be output. If “do not execute” is selected, the stapling is not performed. In other choices, “upper right”, “upper left”, “lower right”, “lower left”, “right”, “top”, “left”, or “bottom” can be selected. The setting is for performing the stapling to the individual positions.

A finishing setting 316 is for selecting a finishing method to the physical paper to be printed in a case where it is determined in the number of copies setting 310 that a plurality of copies are specified. If “sort” is set, the logical pages included in the print data are sequentially printed, and the processing is repeated the number of times specified in the number of copies setting 310.

If “group” is set, the logical pages included in the print data are repeatedly printed the number of times specified in the number of copies setting 310, and the processing is performed to the all logical pages.

The settings to CMS processing, which can be set in the CMS tab 305 are described. The settings are valid if the color mode setting 307 is set to “color”. The processor 101 performs the CMS processing to each object included in the print data according to input profile settings 317 to 319, output profile settings 320 to 322, and matching modes 323 to 325. To color information included in each object, the CMS processing is performed according to these settings.

Other image processing that can be set in the image processing tab 306 is described. If “monochrome” is selected in the color mode setting 307, the processor 101 transforms the color information (color) included in each object in the print data into gray data according to transformation method specified in gray-scale transformation methods 326 to 328.

The gray-scale transformation methods 326 to 328 can beset for each object type of text, graphic, and image depending on the object types in the print data. In the setting, for example, “sRGB”, “NTSC”, or “EQUAL RGB” can be selected. The processor 101 calculates Gray based on the following equations respectively:

sRGB: Gray=0.21×Red+0.72×Green+0.07×Blue

NTSC: Gray=0.3125×Red+0.5625×Green+0.1250×Blue

EQUAL RGB: Gray=(Red+Green+Blue)/3.

Gray compensation settings 329 to 331 are for outputting a gray data part in color information included in each object in the print data in a single color of K not in a mixed color of CMYK. If the settings are set to “execute”, the processor 101 does not perform the CMS processing on a part of the data in which the color information included in the target object is R=G=B, or C=M=Y.

Digital image correction settings 332 to 334 are for automatically performing correction to an image object. The setting is valid if the color mode setting 307 is set to “color”.

In the setting 332 for correcting face to bright face, if “execute” is selected, the processor 101 detects a face in the image object and performs brightness correction processing. In the red-eye correction setting 333, if “execute” is selected, the processor 101 detects a part of red-eye in the image object and performs color saturation correction processing. In the automatic picture correction setting 334, if “execute” is selected, the processor 101 corrects the contrast and the brightness of the whole image object.

The character black print setting 335 is for outputting the data without performing the CMS processing if the color of a text object is R=G=B=0, C=M=Y=100%, or K=100%.

The application amount limitation setting 336 is for setting a limitation to the sum total of toner amounts of each CMYK plane in the image to be output. The toner application amount limitation is a setting for limiting the toner amount within an acceptable limit in a case where the toner amount that can be used in one pixel is limited by a limitation of the printer engine 112.

For example, if the limitation is 240%, in a case of a color of C=100%, M=100%, Y=60%, and K=0%, the total is 260%. In this case, the value exceeds the limitation. In such a case, by performing inverse under color remove (UCR) processing to C=90%, M=90%, Y=50%, and K=10%, the value can be set within the toner application amount limitation of 240%. The above-mentioned method does not limit the exemplary embodiment of the present invention, other methods can be used to set the toner application amount within the limitation.

A button 337 for returning to standard disposed to the right in FIGS. 2A, 2B, and 2C is for initializing each setting. If the button 337 is selected, the processor 101 initializes each setting in the display to default setting of the apparatus.

A charge display box 338 disposed at the left in FIG. 2A is for displaying a charge to notify the user of the charge necessary in a case where print processing is performed based on the print settings set by the print settings 307 to 336.

In the above-described settings, some settings do not relate to toner amount calculation. For example, the two-sided printing setting 314 and the staple setting 315 do not relate to the toner amount calculation.

### <Module Configuration>

Referring to FIG. 3, by specifically focusing on the preview function according to the present exemplary embodiment, the module configuration is described. FIG. 3 illustrates an example of the module configuration of the image forming apparatus.

A spool unit 213 is implemented by the disk device 103. The rasterization unit 204 is implemented by the RIP device 111. A print data reception unit 219 is implemented by receiving print data transmitted from another computer 221 via a network 220. The other units are implemented by executing a program stored in the memory 102 by the processor 101. A processing procedure is stored as the program in the memory 102.

The print data reception unit 219 receives print data to be previewed and stores the data as the print data 214 in the spool unit 213.

A preview display/update instruction reception unit 201 receives selection of the preview button 302. A print setting reception unit 202 acquires each print setting information displayed on the settings 307 to 336. The interpretation unit 203 interprets the target print data 214 according to a PDL syntax using the print settings. The rasterization unit 204 forms a full-size image 216 using the result interpreted by the interpretation unit 203.

A print data feature quantity calculation unit 206 calculates a feature quantity from the full-size image 216 formed by the rasterization unit 204. In addition, the print data feature quantity calculation unit 206 simultaneously stores the print data feature quantity and the print settings as print setting record data 218. A detailed toner amount calculation unit 209 calculates a toner amount based on the print data feature quantity. The detailed toner amount calculation unit 209 is an example of a second toner amount calculation unit.

A print setting change extraction unit 205 extracts a difference between the print setting record data 218 and the print settings received in the print setting reception unit 202, and stores the difference as print setting difference data 222. A toner amount same magnification variation calculation unit 207 calculates a toner amount same magnification variation using the changed print settings and print data feature quantity 217.

A toner amount same magnification variation determination unit 208 determines whether the toner same magnification variation calculated in the toner amount same magnification variation calculation unit 207 is equal to or greater than a threshold or less than the threshold. A simple toner amount calculation unit 210 simply calculates a toner amount using the print data feature quantity 217 and the print setting difference data 222.

The simple toner amount calculation unit 210 is an example of a first toner amount calculation unit. A charge calculation unit 211 calculates a charge based on the toner amount calculated in the detailed toner amount calculation unit 209 or the simple toner amount calculation unit 210. A preview image updating unit 223 generates a preview image 215 based on the full-size image 216. A preview display unit 212 displays the preview image 215 and the charge.

Although not described in detail for the sake of simplicity, the system includes a unit for printing the contents of the print data on physical paper by the following procedure in response to reception of selection of the print button 301. The following procedure includes, receiving the print settings by the print setting reception unit 202, interpreting the print data by the interpretation unit 203, and forming the full-size image 216 by the rasterization unit 204. The full-size image 216 is printed on the physical paper by the printer engine 112 and output.

### <Toner Amount Calculation Method>

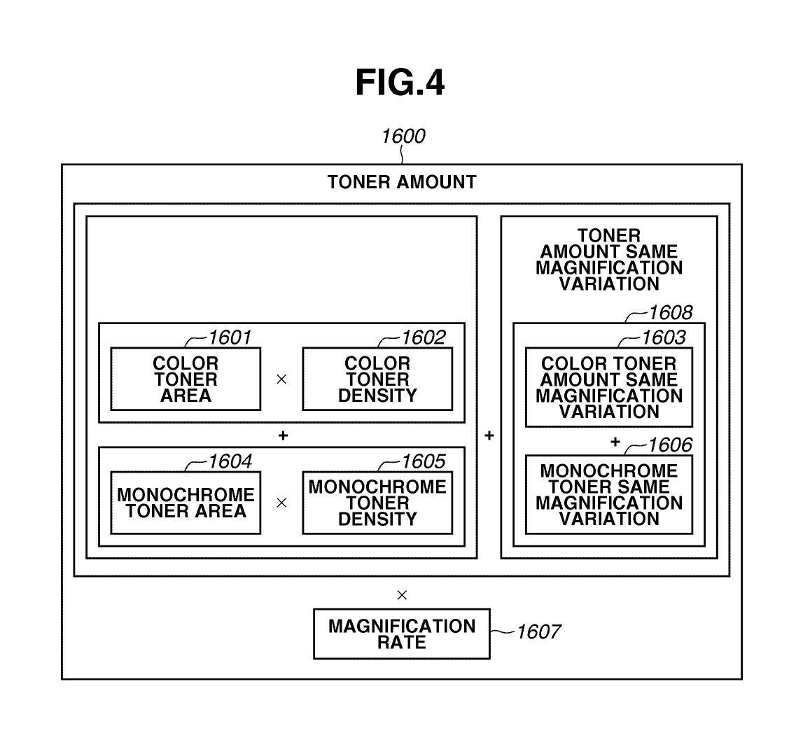

First, referring to FIG. 4, the logic of the toner amount calculation is described. In the present exemplary embodiment, a toner amount in one page is divided into color and monochrome. Further, for convenience in calculation in a case where a print setting is changed, the toner amount is divided into area, density, and equal magnification variation.

A monochrome toner area 1604 means an area of monochrome pixels on the full-size image 216. The monochrome pixels, if the image is an RGB image, satisfy R=G=B, and if the image is CMYK image, satisfy C=M=Y.

A pixel of color does not satisfy the above-mentioned conditions. A monochrome toner density 1605 means a density of the monochrome pixels on the full-size image 216. That is, the sum of the densities of the C plate, the M plate, the Y plate, and the K plate. By multiplying the monochrome toner area 1604 by the monochrome toner density 1605, the toner amount to the monochrome pixels in the case where the print setting change is not performed can be calculated.

On the other hand, the toner amount that increases by the print setting change is managed as a monochrome toner amount same magnification variation 1606.

Similarly, a color toner area 1601, a color toner density 1602, and a color toner amount same magnification variation 1603 are provided. Basically, the elements differ from the above-mentioned elements in whether the target pixels are monochrome or color. Accordingly, descriptions of those elements are omitted.

The sum of the color toner amount same magnification variation 1603 and the monochrome toner amount same magnification variation 1606 is a toner amount same magnification variation 1608. If the value is larger than a predetermined value, an influence rate (variation) to the image before the setting change also increases. In such a case, the calculation of the toner amount is to be accurately performed. If the value is smaller than the predetermined value, the influence rate (variation) to the image before the setting change is small. In such a case, a value by rough estimation can be displayed.

A toner amount 1600 that is an estimated value of the toner amount in the case where the print setting change is performed can be calculated by multiplying the sum of the toner amount to the color pixels, the toner amount to the monochrome pixels, and the toner amount same magnification variation in the case where the print setting change is not performed by a magnification rate at the area ratio.

### <Overall Processing>

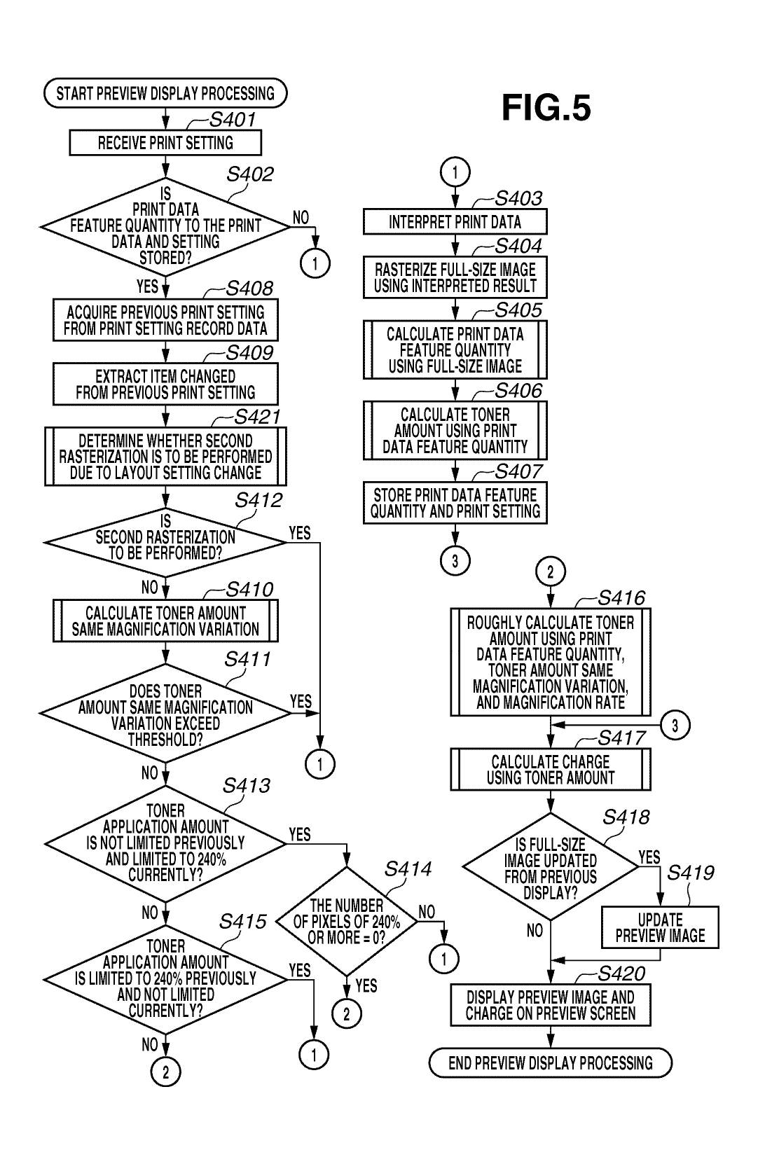

FIG. 5 is a flowchart illustrating an overall flow of displaying a preview image. In a state the print data 214 to be a target in FIGS. 2A to 2C is being selected, if an instruction of displaying and updating a preview screen is issued by the preview display/update instruction reception unit 201, the processing starts.

In step S401, the print setting reception unit 202 receives the various print settings illustrated in FIGS. 2A to 2C and the print data 214 to be the target. The print setting reception unit 202 stores the various print settings illustrated in FIGS. 2A to 2C as a print setting 224.

In step S402, the print setting reception unit 202 determines whether the print data feature quantity 217 to the combination of the print data 214 and the print setting 224 is stored in the print setting record data 218. If the print data feature quantity 217 is not stored (NO in step S402), in steps S403 to 407, the image forming apparatus implements processing for performing the detailed toner amount calculation. If the print data feature quantity 217 is stored (YES in step S402), the image forming apparatus tries to perform the simple toner amount calculation. In the description, first, the case in which the print data feature quantity 217 is not stored is described.

In the case where the print data feature quantity 217 relating to the print data 214 is not stored in the print setting record data 218, the image forming apparatus forms the full-size image 216 from the print data 214, and performs the detailed toner amount calculation based on the formed image.

In step S403, the interpretation unit 203 performs interpretation processing of the print data based on the print data 214 and a print setting 224. In step S404, using the interpreted result, the rasterization unit 204 forms the full-size image 216.

The full-size image 216 includes the above-mentioned two types of planes of an image plane 225 and an attribute plane 226. In step S405, the print data feature quantity calculation unit 206 calculates the print data feature quantity 217 using the image plane 225 and the attribute plane 226. The processing is described in detail below.

In step S406, the detailed toner amount calculation unit 209 calculates a toner amount 227 based on the print data feature quantity 217. In step S407, the detailed toner amount calculation unit 209 associates the print data feature quantity 217, the print setting 224, and the toner amount 227 with each other, and stores the data as the print setting record data 218.

In the case where the print data feature quantity 217 associated with the print data 214 is stored in the print setting record data 218, the toner amount same magnification variation determination unit 208 calculates a toner amount same magnification variation from the changed print setting, and if possible, applies the simple toner amount calculation unit 210.

In step S408, the toner amount same magnification variation determination unit 208 acquires the previous print setting from the print setting record data. The toner amount same magnification variation determination unit 208 calculates a difference between the previous setting and the print setting 224 currently being set, and stores the difference as the print setting difference data 222.

In step S421, first, the toner amount same magnification variation determination unit 208 determines whether second rasterization is necessary due to the change in the print setting about the layout. The processing is described in detail below. As a result, in step S412, if the toner amount same magnification variation determination unit 208 determines that the second rasterization is necessary (YES in step S412), the toner amount same magnification variation determination unit 208 goes to sequential processing for the detailed toner amount calculation.

In step S410, the toner amount same magnification variation determination unit 208 calculates the toner amount same magnification variation based on the print setting difference data 222. The processing is described in detail below. In step S411, if the toner amount same magnification variation exceeds a threshold (YES in step S411) , the toner amount same magnification variation determination unit 208 goes to the sequential processing for the detailed toner amount calculation.

If the print size specification is set to “automatic”, according to the specification of the page size in the print data, the output paper size is selected. If the print size specification is set to a fixed size such as “A4” and “A3” other than the specification of “automatic”, the fixed size is selected as the output paper size.

If the print area extension is not specified, margins are set to upper, lower, right, and left ends of the paper, and layout processing is performed within the area. If the print area extension is specified, the layout processing is performed on the entire paper.

If the enlargement/reduction is specified to the paper size, each logical page of the print data is enlarged or reduced and output within the area where the layout processing is performed. If the enlargement/reduction is not specified to the paper size, the data is drawn at the same magnification within the area where the layout processing is performed.

In step S413, in the print setting difference data 222, if the toner application amount is not limited previously, and limited to 240% currently (YES in step S413), in step S414, the toner amount same magnification variation determination unit 208 determines whether the information of the number of pixels of 240% or more in the print data feature quantity is one or more.

If the number of pixels is one or more (NO in step S414), the toner amount same magnification variation determination unit 208 goes to the sequential processing for the detailed toner amount calculation. If not (YES in step S414), the toner amount same magnification variation determination unit 208 goes to the sequential processing for simple toner amount calculation described below.

In the print setting difference data 222, if the toner application amount is limited to 240% previously, and not limited currently (YES in step S415), the toner amount same magnification variation determination unit 208 goes to the sequential processing for the detailed toner amount calculation.

If not, that is, if the toner application amount limitation is not changed (NO in step S415), the toner amount same magnification variation determination unit 208 goes to the sequential processing for the simple toner amount calculation described below.

In step S416, the simple toner amount calculation unit 210 performs the simple toner amount calculation processing for calculating the toner amount using the print data feature quantity, the toner amount same magnification variation, and the magnification rate. The processing is described in detail below.

In step S417, in response to the toner amount calculation by the detailed toner amount calculation unit 209 or the simple toner amount calculation unit 210, the charge calculation unit 211 calculates a charge from the toner amount. The processing is described in detail below.

In step S418, in response to the processing in step S417, the preview image updating unit 223 determines whether the full-size image 216 is updated. If the full-size image 216 is updated (YES in step S418), in step S419, the preview image updating unit 223 updates the preview image. In step S420, the preview image updating unit 223 displays the preview image and the charge on the preview screen.

By the above-described processing, if the print setting is largely changed due to the print setting change, the detailed toner amount calculation processing with the second rendering of the image is performed. If the print setting is not largely changed, based on the stored information, the simple toner amount calculation processing is performed.

### <Print Data Feature Quantity Calculation Processing>

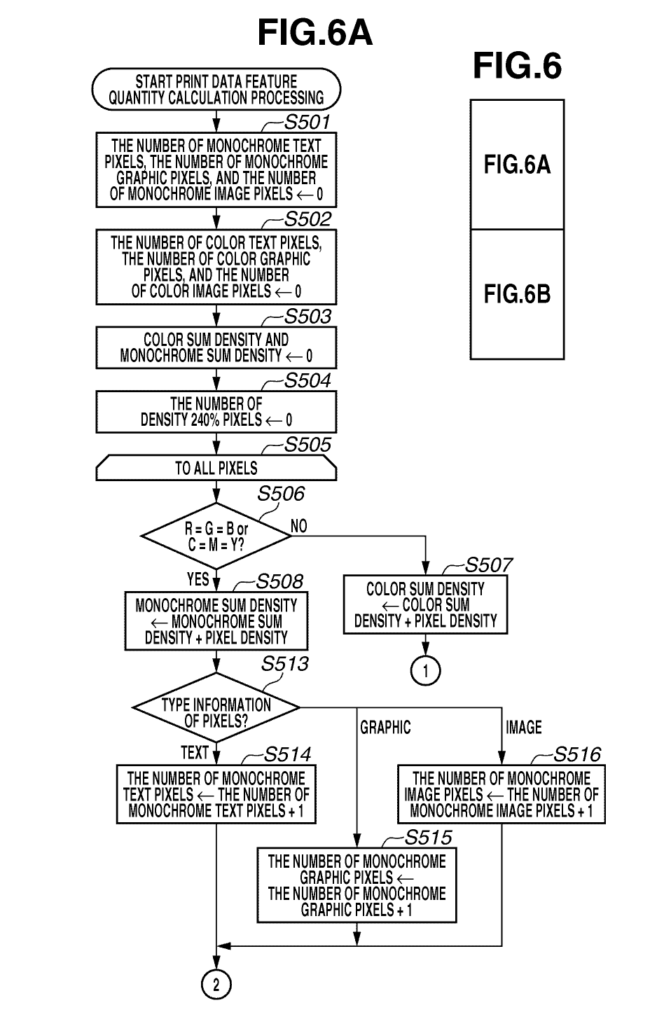

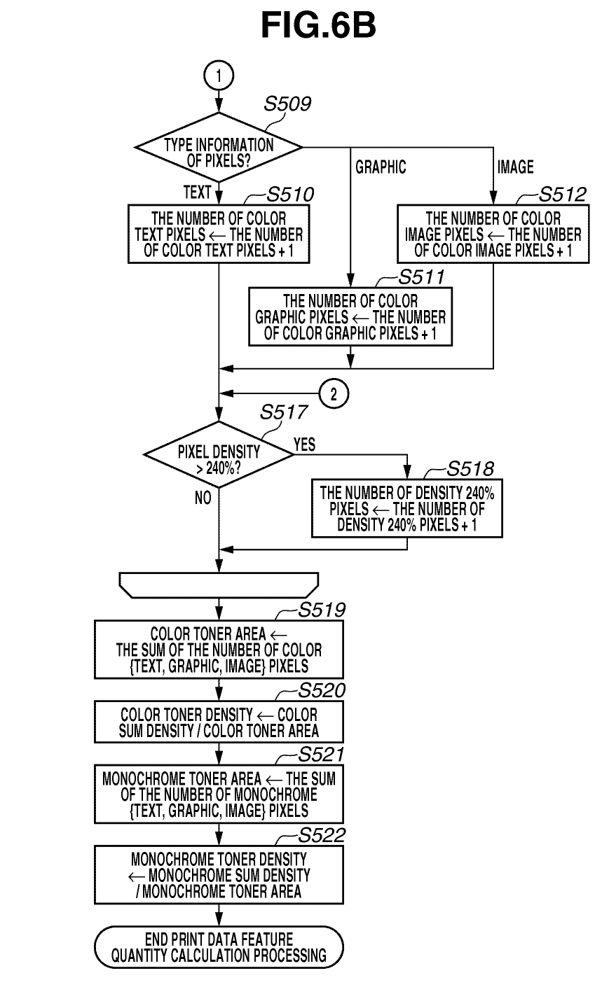

FIG. 6 is a flowchart illustrating processing of calculating the print data feature quantity from the full-size image in step S405. The processing is performed by the print data feature quantity calculation unit 206.

Insteps S501 and 502, the print data feature quantity calculation unit 206 initializes the values of the individual counters of the number of pixels to zero. In step S503, further, the print data feature quantity calculation unit 206 initializes the color sum density, the monochrome sum density, and the number of the density 240% pixels with zero.

In steps S505 to 518, the print data feature quantity calculation unit 206 repeatedly performs the following processing to the all pixels.

First, in step S506, the print data feature quantity calculation unit 206 determines whether the pixel is color or monochrome. If R=G=B or C=M=Y, the print data feature quantity calculation unit 206 determines that the pixel is monochrome.

If the print data feature quantity calculation unit 206 determines that the pixel is monochrome (YES in step S506), in step S508, the print data feature quantity calculation unit 206 adds the density of the pixel currently being processed to the monochrome sum density. In step S513, the print data feature quantity calculation unit 206 determines the object type information of the pixel. Depending on the information, in corresponding step in steps S514 to 516, the print data feature quantity calculation unit 206 increments the value of the counter of the number of pixels by one.

If the print data feature quantity calculation unit 206 determines that the pixel is color (NO in step S506), in step S507, the print data feature quantity calculation unit 206 adds the density of the pixel currently being processed to the color sum. density. In step S509, depending on the object type information of the pixel, in corresponding step in steps S510 to 512, the print data feature quantity calculation unit 206 increments the value of the counter of the number of pixels by one.

In step S517, the print data feature quantity calculation unit 206 determines whether the density of the target pixel exceeds 240%. If the density exceeds 240% (YES in step S517), in step S518, the print data feature quantity calculation unit 206 increments the number of the density 240% pixels by one.

By repeatedly performing the above-described processing to the all pixels by the print data feature quantity calculation unit 206, the frequency information based on the color/monochrome information of the pixels and the object type information can be acquired.

In step S519, the print data feature quantity calculation unit 206 calculates the sum of the number of the pixels whose color/monochrome information is color as a color toner area. In step S520, by dividing the color sum density by the color toner area, the color toner density can be calculated.

Similarly, in step S521, the print data feature quantity calculation unit 206 calculates the sum of the number of the pixels whose color/monochrome information is monochrome as a monochrome toner area. In step S522, by dividing the monochrome sum density by the monochrome toner area, the monochrome toner density can be calculated.

The frequency information based on the color/monochrome information and the object type information, the number of the pixels whose density exceed 240%, and the toner density information based on the color/monochrome information acquired by the above-described processing constitute the print data feature quantity 217.

### <Detailed Toner Amount Calculation Processing>

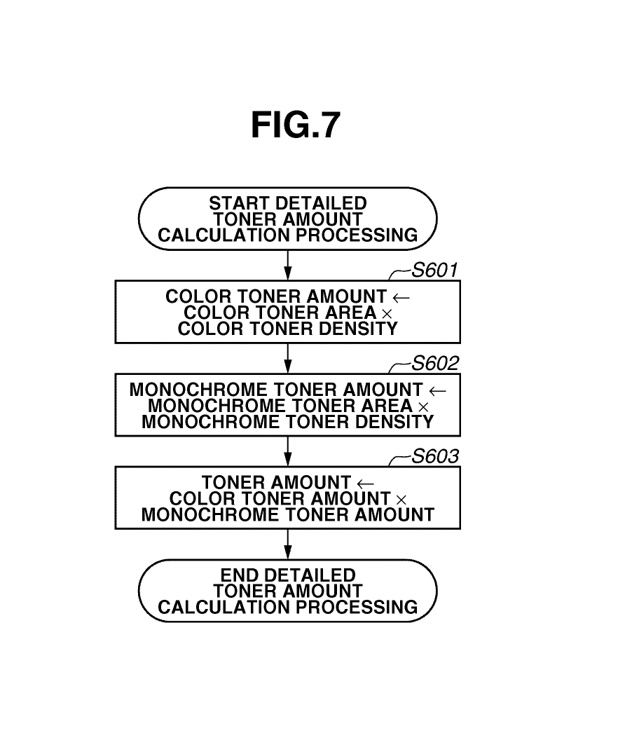

FIG. 7 is a flowchart illustrating the processing of calculating a toner amount from a print data feature quantity. The processing is performed by the detailed toner amount calculation unit 209.

In step S601, the toner amount that is used in the pixels classified to be processed in color using the color/monochrome information is acquired by multiplying the color toner area 1601 and the color toner density 1602 included in the print data feature quantity 217.

In step S602, the toner amount that is used in the pixels classified to be processed in monochrome is acquired by multiplying the monochrome toner area 1604 and the monochrome toner density 1605 included in the print data feature quantity 217. In step S603, the toner amount 1600 is acquired by adding the color toner amount and the monochrome toner amount.

At this point, it is not necessary to consider the toner amount same magnification variation 1608 and the magnification rate 1607.

### <Charge Calculation Processing>

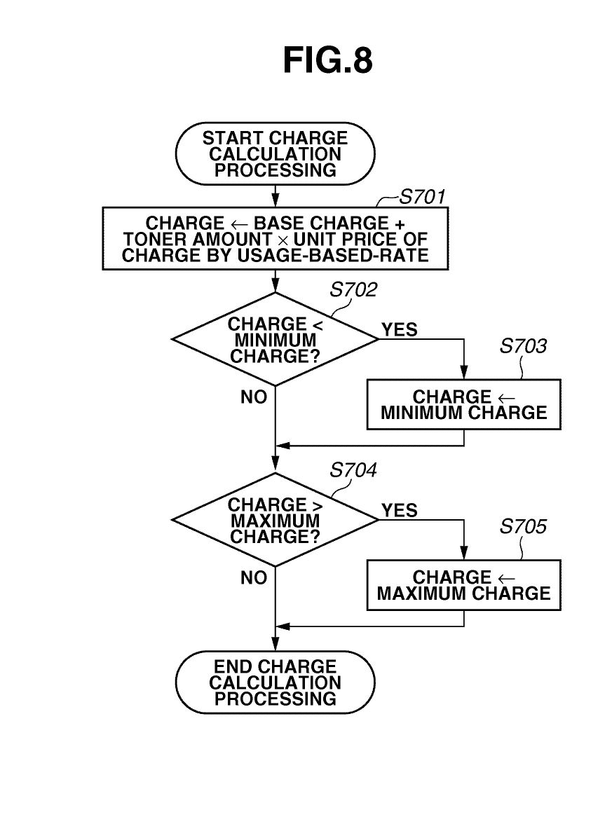

FIG. 8 is a flowchart illustrating the processing of calculating a charge from a toner amount. The processing is performed by the charge calculation unit 211. Various methods for calculating the charge using the toner amount 1600 can be designed.

In step S701, the charge calculation unit 211 considers that the charge includes a base charge and a charge by usage-based-rate. The base charge is a charge for one sheet, and the base charge is constant regardless of the toner amount 1600. The charge by usage-based-rate increases as the toner amount 1600 increases.

The charge by usage-based-rate is calculated by multiplying the toner amount 1600 by a unit price of the charge by usage-based-rate. For example, the base charge is 6 yen per sheet (A4) , and the charge by usage-based-rate is 6 yen per plate (A4) . In the present exemplary embodiment, the unit price of the charge by usage-based-rate is the amount of money per one plate in the A4 size. For example, if the entire A4-size sheet is filled with the density of 100% of a C plate, the charge is 6.0 yen. Under the same conditions, if half of the A4-size sheet is filled with the density of 100%, or the entire A4-size sheet is filled with the density of 50%, the charge is 3 yen.

In step S702, if the calculated charge is less than a minimum charge (YES in step S702), in step S703, the charge calculation unit 211 sets the charge to the minimum charge. In step S702, if the calculated charge exceeds a maximum charge (NO in step S702), in step S704, the charge calculation unit 211 sets the charge to the maximum charge.

By the processing, in a case where toner of only less than a certain threshold is used, or toner exceeding the certain threshold is used, the charge is set within a certain range.

### <Second Rasterization Determination Processing>

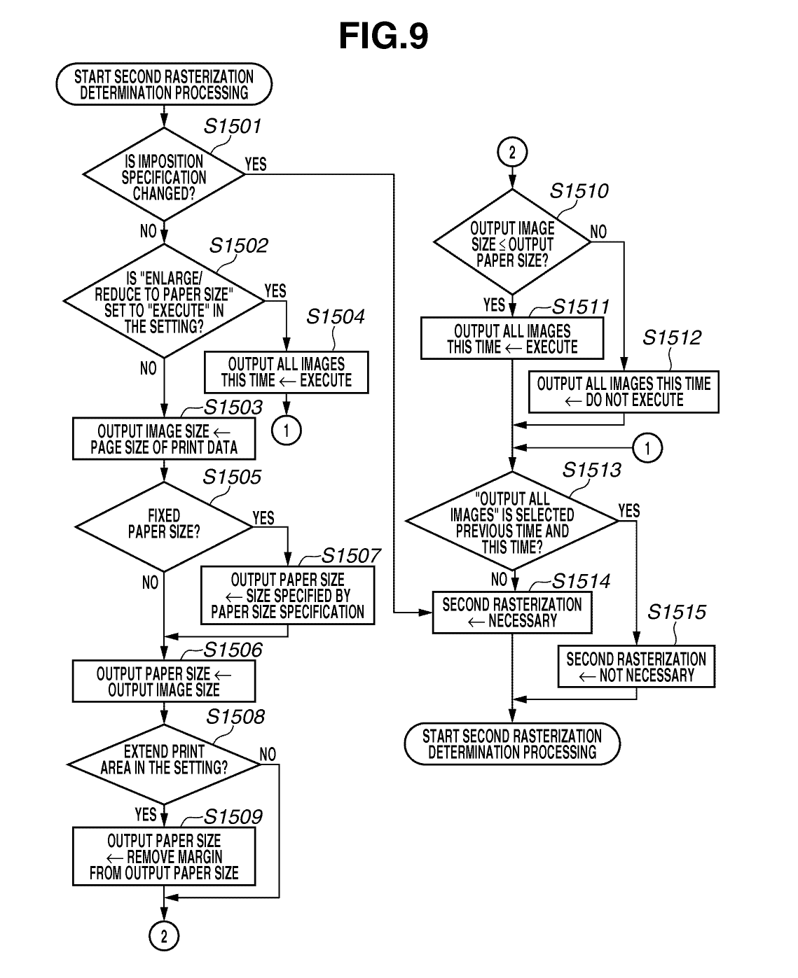

FIG. 9 is a flowchart illustrating processing of determining whether second rasterization is to be performed in response to a layout change. First, whether all pages in print data is to be output as an image in one rasterization processing is to be determined. In the description, the determination result is referred to as an all image output.

In step S1501, first, the toner amount same magnification variation determination unit 208 determines whether an imposition specification is changed. If it is determined that the imposition specification is changed (YES in step S1501), in step S1514, the toner amount same magnification variation determination unit 208 determines that a second rasterization processing is to be performed, and ends the processing.

In step S1502, if the toner amount same magnification variation determination unit 208 determines whether the enlargement/reduction setting of the paper size is set to “execute” in the setting of this time. If the enlargement/reduction setting of the paper size is set to “execute” (YES in step S1502), the toner amount same magnification variation determination unit 208 sets the all image output setting of this time to “execute”, and performs determination processing (from step S1513 to step S1515) described below.

If the enlargement/reduction setting of the paper size is not set to “execute” (NO in step S1502), in step S1503, the toner amount same magnification variation determination unit 208 sets the output image size to the page size of the print data.

In step S1505, if the specification of the paper size of this time is specified to “fix (A4, A3, . . . )” (YES in step S1505) , in step S1507, the toner amount same magnification variation determination unit 208 sets the specified size as the output paper size. If the specification of the paper size is specified to “automatic” (NO in step S1505), in step S1506, the toner amount same magnification variation determination unit 208 sets the output image size as the output paper size.

In step S1508, the toner amount same magnification variation determination unit 208 checks the print area extension specification. If the print area extension specification is set to “execute” (YES in step S1508), in step S1509, the toner amount same magnification variation determination unit 208 removes the margin from the output paper size. The toner amount same magnification variation determination unit 208 can specify, for example, 5 mm for the margin.

In step S1510, the toner amount same magnification variation determination unit 208 determines whether the output image size acquired by the above-described processing is within the output paper size. In this step, the toner amount same magnification variation determination unit 208 also checks the orientation of the paper.

If the output image size is equal to or less than the output paper size (YES in step S1510), in step S1511, the toner amount same magnification variation determination unit 208 sets the all image output setting of this time to “execute”. If the output image size is greater than the output paper size (NO in step S1510), in step 1512, the toner amount same magnification variation determination unit 208 sets the all image output setting of this time to “do not execute”.

The toner amount same magnification variation determination unit 208 can use the width and height as criteria in consideration of the orientation of the paper. Alternatively, the toner amount same magnification variation determination unit 208 can focus on only the size of the paper, and the long side and the short side of the paper can be used as the criteria. Alternatively, the toner amount same magnification variation determination unit 208 can use a certain criterion depending on the print setting.

In the above-described step S1504, step S1511, or step S1512, whether the all image output of this time is to be performed is determined. Further, the toner amount same magnification variation determination unit 208 adds the result of the previous all image output determination to the determination, and if “execute” is selected in both determinations (YES in step S1513), in step S1515, the toner amount same magnification variation determination unit 208 determines that the second rasterization processing is not to be performed.

In such a case, in both before and after the setting, the print data of one page is rendered in one rendering processing without lack. If “do not execute” is selected in at least one of the determinations (NO in step S1513), in step S1514, the toner amount same magnification variation determination unit 208 determines that the second rasterization processing is to be performed. In such a case, a part of the image may lack, and in the sequence for detailed toner calculation processing, the toner amount is to be calculated.

### <Toner Amount Same Magnification Variation Determination Processing>

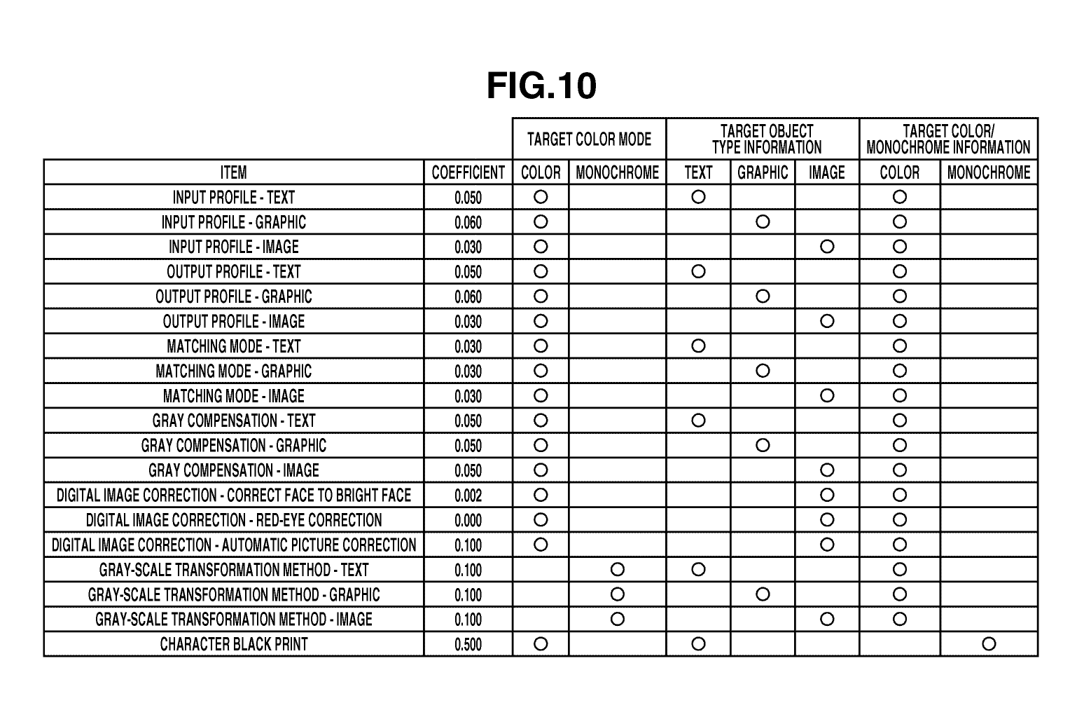

FIG. 10 illustrates an example of an influence coefficient table used for calculating a toner amount same magnification variation if a print setting difference exists. Description will be made from the left columns.

The column of “item” indicates names of the print settings. The item “input profile—text” at the top indicates, in input profile settings, a setting part relating to a text. The column of “coefficient” indicates how much the setting change influences a pixel of 100%. In the item “input profile—text”, the variation of 0.050, that is, the variation of 5% exists.

The column “target color mode” indicates a limitation relating to a current color mode set in the color mode setting 307. In the case of the item “input profile—text”, if the color mode is set to “color”, it includes “white circle”, that means “valid”, and if the color mode is set to “monochrome”, it includes “nothing” that means invalid l.

The column “target object type” indicates a limitation relating to the object type of the target pixel. In the case of the “input profile—text”, to a pixel whose object type is “text”, the limitation is valid, however, to a pixel whose object type is “graphic” or “image”, the limitation is invalid.

The column “target object color” indicates a limitation relating to the color/monochrome information of the target pixel. In the case of the “input profile—text”, to a pixel whose color/monochrome information is “color”, the limitation is valid, however, to a pixel whose color/monochrome information is “monochrome”, the limitation is invalid.

For example, in the item “digital image correction: red-eye correction”, if the correction processing is performed on the image, only a small part is influenced. Accordingly, the coefficient is set to 0.00. In the case of “digital image correction: automatic picture correction”, the correction processing is performed on the entire of the image. Accordingly, the coefficient is set to 0.10.

These coefficients can be determined by an empirical rule, or by a determination method based on statistics. In the exemplary embodiment, only the simple conditions are employed in the limitation conditions. However, further detailed print data feature quantities are calculated, and based on the feature quantities, the limitations can be classified into further detailed limitations. These limitations can be extended within the scope of the exemplary embodiment.

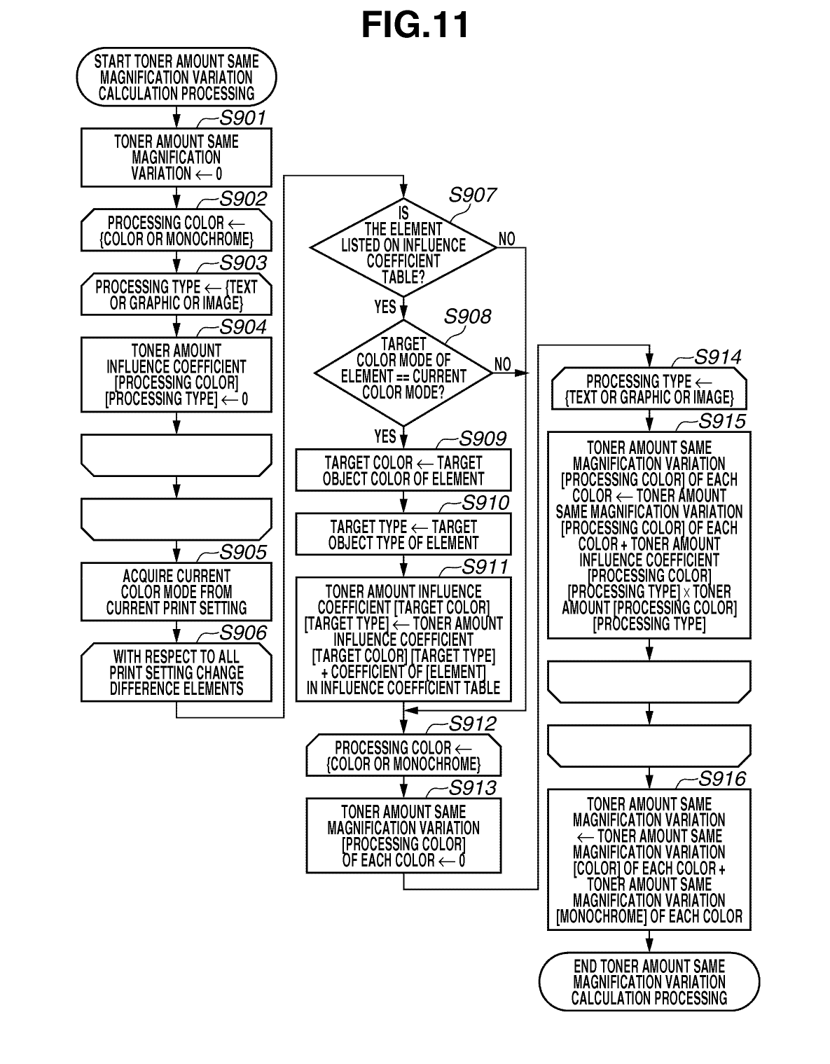

FIG. 11 is a flowchart illustrating processing of calculating a toner amount same magnification variation from a print setting difference. The processing is performed by the toner amount same magnification variation calculation unit 207.

In step S901, the toner amount same magnification variation determination unit 207 initializes the toner amount same magnification variation to zero. Further, in step S902, the toner amount same magnification variation calculation unit 207 initializes all of “color” and “monochrome” as the color/monochrome information, in step S903, “text”, “graphic”, and “image” as the object type information, and in step S904, the toner amount influence coefficients [processing color] and [processing type] by zero.

The toner amount influence coefficients [color] and [image] indicate influence rates given by a setting change in a case where the color/monochrome information of a target pixel is “color”, and the object type information is “image”. In step S905, the toner amount same magnification variation calculation unit 207 acquires the current color mode from the current print setting 224.

The toner amount same magnification variation calculation unit 207 calculates a toner amount influence coefficient to each color/monochrome information and each object type information using the stored print setting difference data 222 and the influence coefficient table illustrated in FIG. 10. In step S906, to all difference elements contained in the print setting difference data 222, in step S907, the toner amount same magnification variation calculation unit 207 checks whether the elements are included in the influence coefficient table.

If the element is not included in the influence coefficient table (NO in step S907), the toner amount same magnification variation calculation unit 207 skips the following processing. If the element is included in the influence coefficient table (YES in step S907), in step S908, the toner amount same magnification variation calculation unit 207 checks whether the target color mode of the element corresponds to the current color mode.

If the element does not correspond to the current color mode (NO in step S908), the toner amount same magnification variation calculation unit 207 skips the following processing. If the element corresponds to the current color mode (YES in step S908), in steps S909 and S910, the toner amount same magnification variation calculation unit 207 sets the color/monochrome information of the target of the element to the target color, and sets the object type information to the target type.

In step S911, the toner amount same magnification variation calculation unit 207 searches the influence coefficient table for the columns relating to the elements, and adds the coefficients to the toner amount influence coefficients [target color] and [target type]. By performing the above-described processing to the all elements by the toner amount same magnification variation calculation unit 207, the toner amount influence coefficients in which the all difference elements contained in the print setting difference data 222 are considered can be generated.

Next, the toner amount same magnification variation determination unit 207 actually calculates a toner amount same magnification variation. In step S912, as the color/monochrome information, to both of “color” and “monochrome”, in step S913, the toner amount same magnification variation calculation unit 207 initializes the toner amount same magnification variation [processing color] of each color by zero.

In step S914, to each of “text”, “graphic”, and “image” respectively as the object type information, the toner amount same magnification variation calculation unit 207 calculates a toner amount to be added using the influence coefficient, and adds the toner amount same magnification variation [processing color] of each color.

That is, in step S915, the toner amount same magnification variation calculation unit 207 calculates the toner amount same magnification variation [processing color] of each color by adding the value obtained by multiplying the toner amount influence coefficients [processing color]and [processing type] by the individual toner amounts [processing color]and [processing type] to the toner amount same magnification variation [processing color] of each color.

The toner amount same magnification variation calculation unit 207 repeatedly performs the processing to the all combinations of the color/monochrome information and the object type information.

Finally, in step S916, the toner amount same magnification variation calculation unit 207 determines the sum of the toner amount same magnification variations to both of “color” and “monochrome” as the color/monochrome information to be the toner amount same magnification variation. <Simple toner amount calculation flowchart>

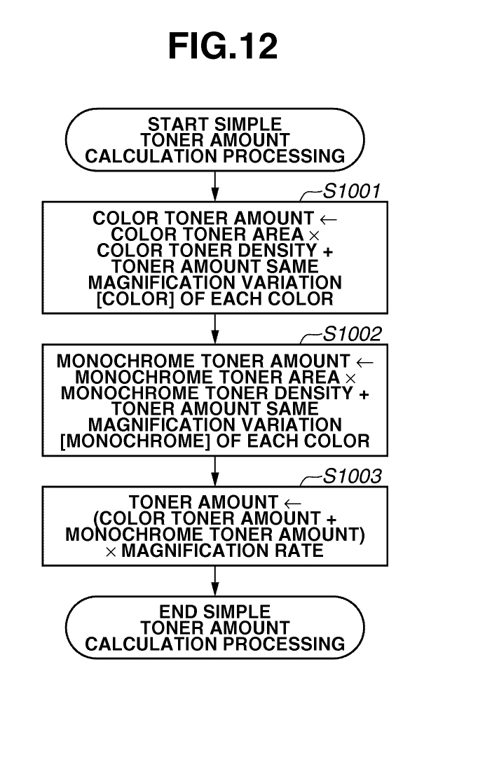

FIG. 12 is a flowchart illustrating processing of calculating a toner amount from a print data feature quantity, a toner amount same magnification variation, and a magnification rate. The processing is performed by the simple toner amount calculation unit 210.

In step S1001, the simple toner amount calculation unit 210 determines a color toner amount by multiplying a color toner area by a color toner density, and adds the value to a toner amount same magnification variation [color] of each color. In step S1002, the simple toner amount calculation unit 210 determines a monochrome toner amount by multiplying a monochrome toner area by a monochrome toner density, and adds the value to a toner amount same magnification variation [monochrome] of each color.

In step S1003, the simple toner amount calculation unit 210 determines a final toner amount by multiplying the sum of the color toner amount and the monochrome toner amount by the magnification rate (area conversion).

### <Example of Actual Calculation>

### <Target Data>

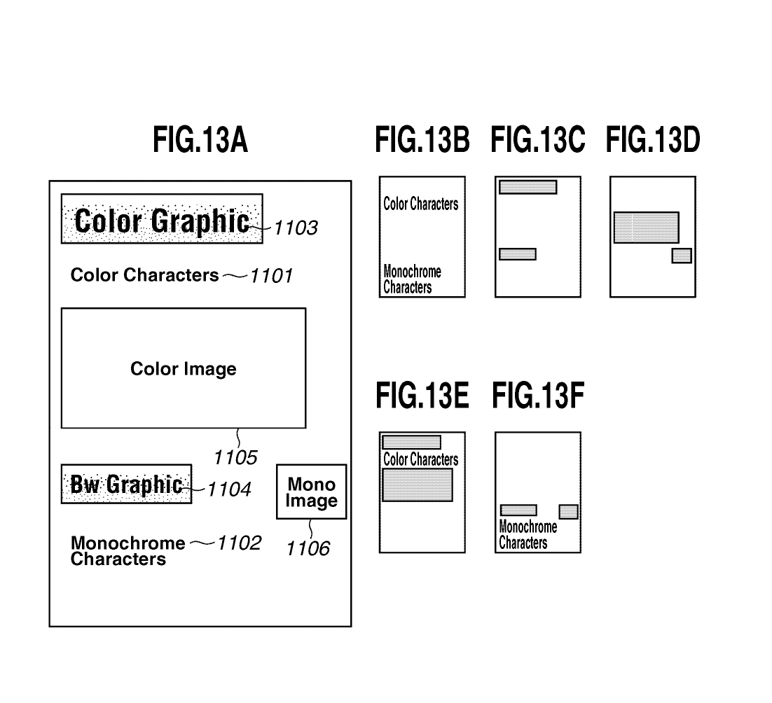

FIGS. 13A to 13F illustrate examples of the print data used in the first exemplary embodiment. FIG. 13A is a schematic view illustrating the target print data. The drawing is the schematic view illustrating a concept of the print data feature quantity. It is noted that the areas on the drawing are not linked to the numeric characters in the specification.

The print data is printed in the height of 7016 pixels and the width of 4960 pixels at the A4 600 dpi. The print data includes a text object 1001, a text object 1002, a graphic object 1003, a graphic object 1004, an image object 1005, and an image object 1006.

The color specification of the text object 1001, the graphic object 1003, and the image object 1005 is set to color. The color specification of the text object 1002, the graphic object 1004, and the image object 1006 is set to monochrome.

If the print data is rasterized, in addition to the image plane image illustrated in FIG. 13A, attribute plane images indicating distribution of individual color/monochrome information and the object type information can be acquired (see FIGS. 13B to 13F).

The color/monochrome information means whether a pixel is drawn in color or in monochrome. The object type image means whether a pixel is drawn as a text, a graphic, or an image.

FIG. 13B illustrates text drawings, and indicates the areas drawn by the texts 1101 and 1102. FIG. 13C illustrates graphics. FIG. 13D illustrates images. FIG. 13E illustrates color drawings, and indicates the areas drawn by the text 1101, the graphics 1103, and the image 1105 whose color specification is color.

FIG. 13F illustrates monochrome drawings, and indicates the areas drawn by the text 1102, the graphics 1104, and the image 1106 whose color specification is monochrome.

In the present exemplary embodiment, as one of the print data feature quantities, the frequency of the number of the pixels having an object in the individual attribute plane is used. In the examples illustrated in FIGS. 13A to 13F, in the text attributes, 1,391,974 pixels are drawn in color. In the drawings, 695,987 pixels are drawn in monochrome.

In the graphic attributes, 5,219,904 pixels are drawn in color, and 3,479,936 pixels are drawn in monochrome. In the image attributes, 10,439,808 pixels are drawn in color, and 3,479,936 pixels are drawn in monochrome.

In the present exemplary embodiment, as another print data feature quantity, the toner densities of the color drawings and the monochrome drawings are used. In the example, the pixels drawn in color are drawn at an average of 230% of density.

This means that the individual pixels are drawn in such a manner that the sum of the densities used in each of the C plate, the M plate, the Y plate, and the K plate is the average of 230%. In the drawings, the sum of the densities used in the pixels drawn in monochrome is an average of 70%.

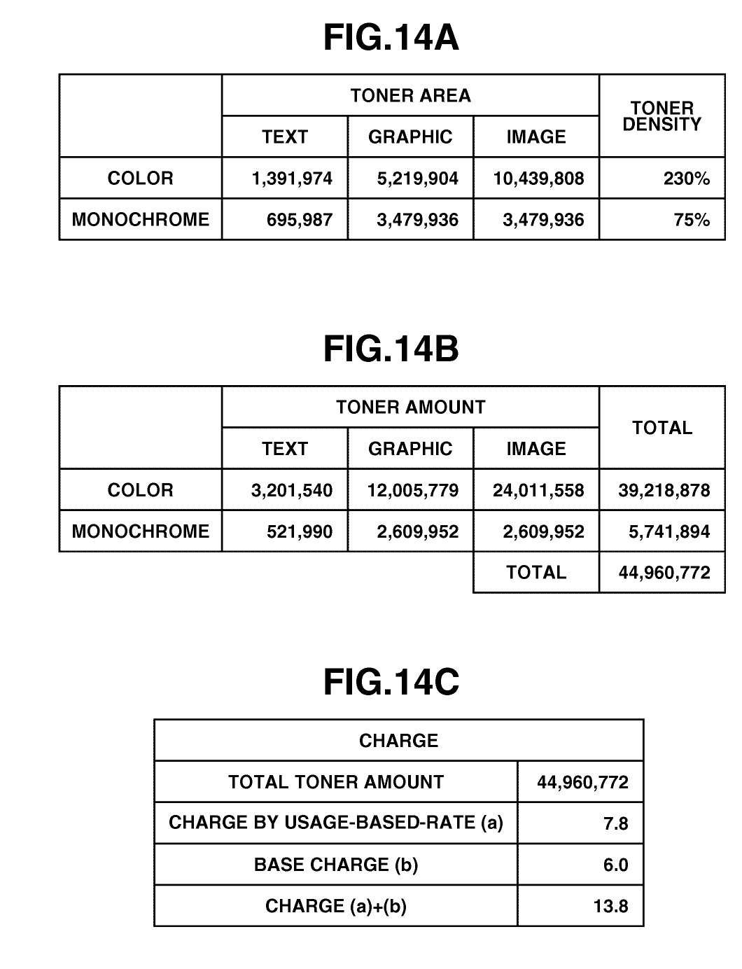

Further, as an additional feature quantity, the number of pixels exceeding a certain threshold is calculated, and the value can be used as one of the print data feature quantities. The feature quantity is information about a toner application amount limitation. The feature quantities calculated by the above-described processing are illustrated in FIG. 14A.

### <Flow of Calculation>

Actual flows of the calculation are described with reference to FIGS. 14A to 14C, FIGS. 15A to 15D, and FIGS. 16A to 16C. As mentioned above, the print data feature quantities to the print data in FIGS. 13 are illustrated in FIG. 14A.

### <Calculation Example 1>

First, an example of processing performed by the sequence for the detailed toner amount calculation is described. When preview display to the data is tried for the first time, the print data feature quantity 217 is not stored.

The image forming apparatus calculates a toner amount based on the print data feature quantities illustrated in FIG. 14A. The toner amount of pixels of the color/monochrome information of “color”, and the object type information of “text” is, as a result of calculation of the number of text pixels 1,391,974×toner density of 230%, 3,201,540 (pixel/plane). FIG. 14B illustrates results of calculation of multiplication of the number of pixels and the toner densities respectively to the all elements similarly performed by the image forming apparatus. The sum of the values of 44,960,772 (pixel/plane) is the toner amount.

The image forming apparatus performs charge calculation based on the toner amount. The sum of the toner amounts is 44,960,772, and the charge by usage-based-rate is 6 yen/plane. Accordingly, the charge by usage-based-rate is, the sum of the toner amounts of 44,960,772,×6.0/34,799,360=7.8 yen. A result of addition of 7.8 yen and the base charge of 6.0 yen is 13.8 yen, and the amount is the charge.

### <Calculation Example 2>

Next, an example of processing performed according to the sequence for the simple toner amount calculation is described. If a new print setting is selected without changing a target file, and preview is selected, the print data feature quantity 217 and the like based on the original print setting 224 are stored as the print setting record data 218.

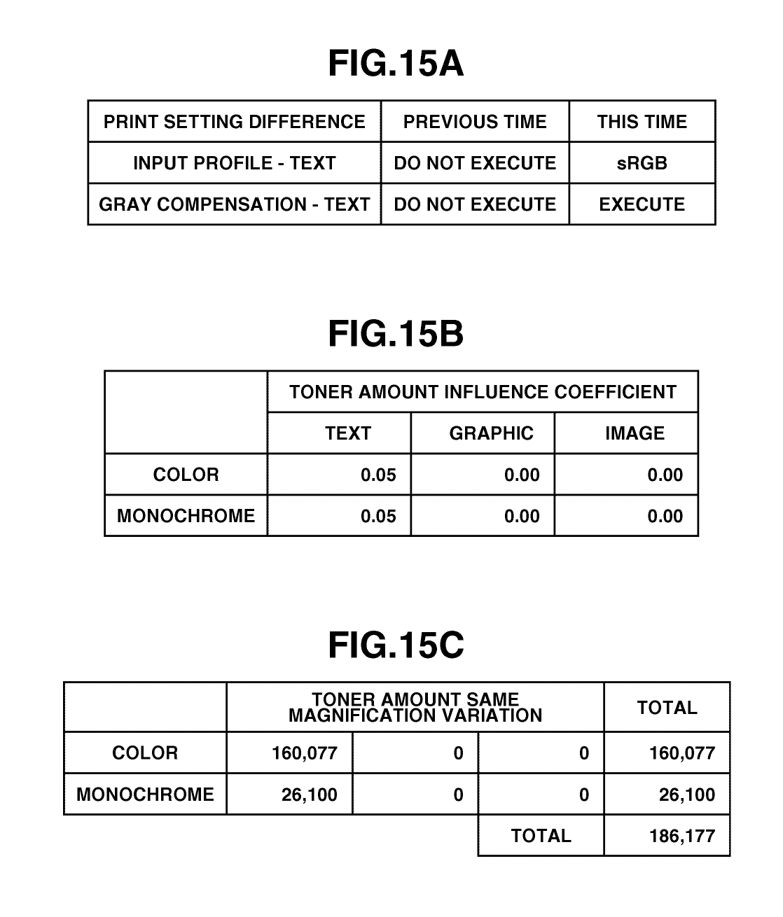

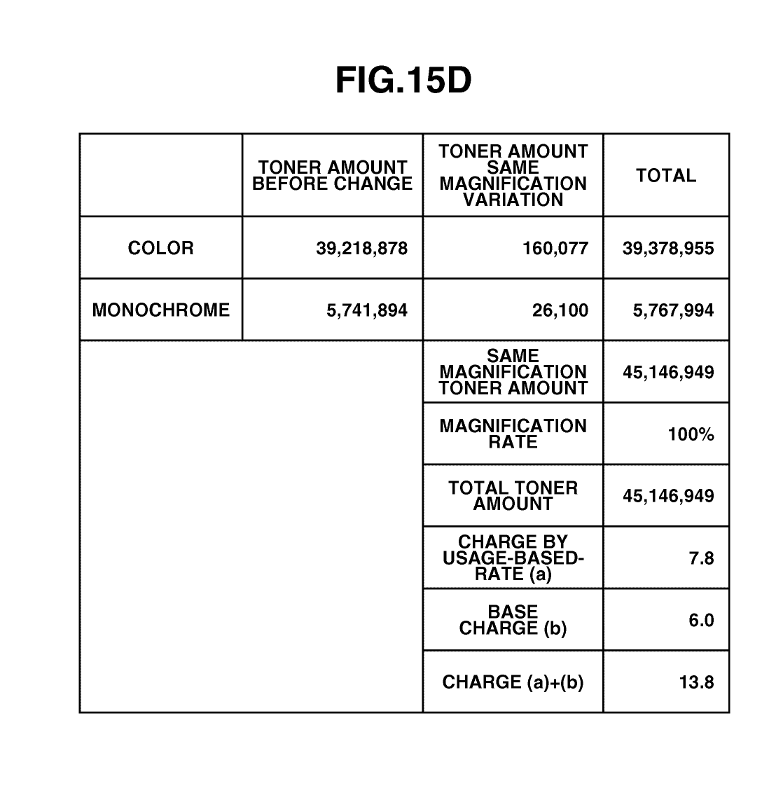

In this example, it is assumed that the print setting of “input profile—text” is changed from “do not execute” to “sRGB”, and the print setting of “gray compensation—text” is changed from “do not execute” to “execute”. FIG. 15A illustrates the print setting differences.

The influence coefficients corresponding to the print setting differences are searched in the influence coefficient table illustrated in FIG. 10. The toner amount influence coefficient corresponding to “input profile—text”, and “color text”, is 0.05. Similarly, the toner amount influence coefficient corresponding to “gray compensation—text”, and “monochrome text”, is 0.05. FIG. 15B illustrates the results of the toner amount influence coefficient calculation.

The image forming apparatus calculates a toner amount same magnification variation of each color. The toner amount same magnification variation to “color text” is calculated by the following equation: toner amount of color texts 3,201,540×toner amount influence coefficient to color texts 0.05=160,077.

Similarly, the toner amount same magnification variation to “monochrome text” is calculated by the following equation: toner amount of monochrome texts 521,990×toner amount influence coefficient to monochrome texts 0.05=26,100. FIG. 15C illustrates the calculation results. The result of the sum of the toner amount same magnification variations is 186,177.

In this example, as the threshold for determining whether the detailed toner amount calculation is to be performed or the simple toner amount calculation is to be performed in step S411, whether a toner amount same magnification variation gives an influence of charge of 0.1 yen or more is used. The toner amount that gives an influence of 0.1 yen is 34,799,360/6.0×0.1=579,989. The toner amount same magnification variation of 186,177 is smaller than the value. Accordingly, in the example, it is determined that the processing can be performed using the simple toner amount calculation.

The color toner amount before the change acquired by multiplying the color toner area by the color toner density is 44,960,772, and then, the color toner amount same magnification variation is 160,007. The sum of the values is 39,378,955. Similarly, the monochrome toner amount before the change acquired by multiplying the monochrome toner area by the monochrome toner density is 5,741,894, and then, the monochrome toner amount same magnification variation is 26,100. The sum of the values is 5,767,994.

In the example, no setting difference that influences the magnification rate is included, and accordingly, the magnification rate is set to 1.0. By the above-described calculation results, the final toner amount is (39,378,955+5,767,994)×1.0=45,146,949. The charge by usage-based-rate to the value is calculated by the following equation: 45,146,949/34,799,360×6.0=7.8. The amount is added to the base charge of 6.0, and the charge is 13.8 yen.

### <Calculation Example 3>

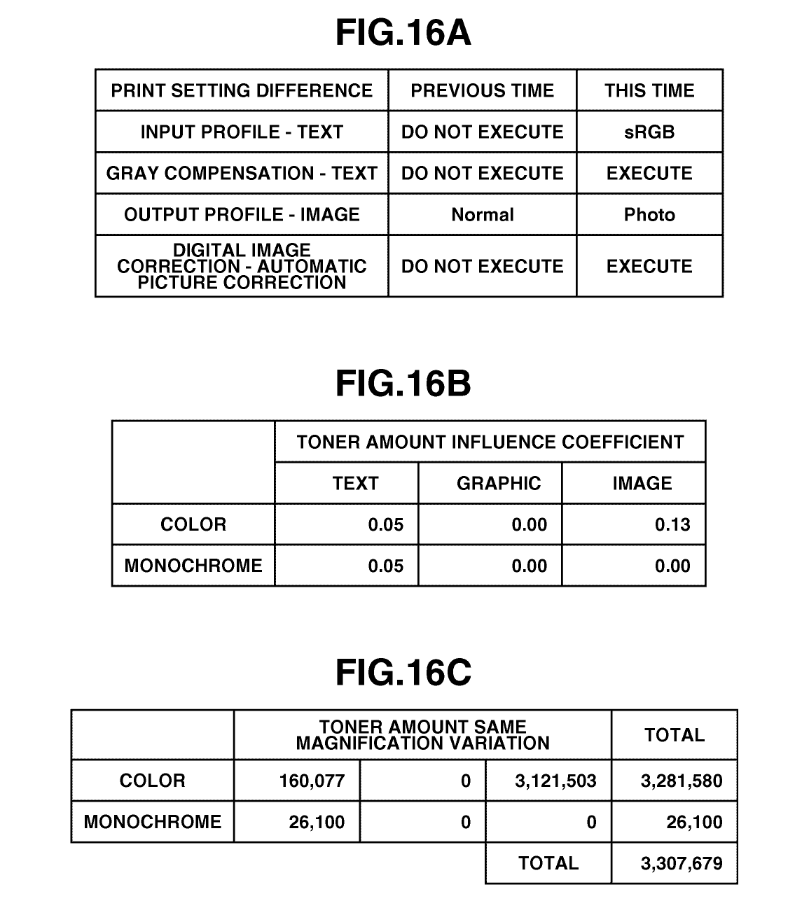

FIGS. 16A to 16C illustrate examples of calculation of adding further changes to the print setting in the calculation example 2. In the example, in addition to the change to the print setting in the calculation example 2, the print setting of “output profile—image” is changed from “Normal” to “Photo”, and the print setting of “gray compensation—text” is changed from “do not execute” to “execute”.

FIG. 16A illustrates the print setting differences. FIG. 16B illustrates toner amount influence coefficients calculated similarly to the calculation example 2. In the example, the settings to the color images are changed. As a result, the coefficient of the part of “color” and “image” increases from 0.00 in FIG. 15B to 0.13.

FIG. 16C illustrates a result of calculation of the added toner amount calculated similarly to the calculation example 2. The toner amount 24,011,558 of the color image is multiplied by the toner amount influence coefficient 0.13 to the color image, and the calculation result of 3,121,503 is the toner amount same magnification variation of the color image.

Using this value, if the toner amount same magnification variation is calculated, (160,077+26,100+3,121,503)=3,307,679. The toner amount that gives an influence of 0.1 yen is 34,799,360/6.0×0.1=579,989. The value exceeds the threshold, and accordingly, it is determined that the toner amount is to be performed by the sequence procedure for performing the detailed toner amount calculation.

As described above, according to the exemplary embodiment, by providing the simple toner amount calculation unit 210 in the image forming apparatus, if the print setting is changed, the toner amount can be calculated quickly. Further, in the image forming apparatus according to the exemplary embodiment, in a case where a change of the print setting information that does not largely influence an output image is performed, the toner amount is calculated by the simple toner amount calculation unit 210.

In the image forming apparatus according to the exemplary embodiment, in a case where a change of the print setting information that largely influences an output image is performed, the toner amount is calculated by the detailed toner amount calculation unit 209. By the operation, the toner amount can be quickly (at a high speed) and accurately calculated.

In the first exemplary embodiment, the toner amounts acquired by the simple toner amount calculation and the detailed toner amount calculation respectively are used substantially equally. However, the toner amount 1600 calculated by the simple toner amount calculation is a roughly calculated value, and the value includes a small error. An exemplary embodiment of differently using the amounts is also useful.

The exemplary embodiment can be easily implemented by switching expressions on the charge display box 338 depending on the simple toner amount calculation and the detailed toner amount calculation. In step S420, the preview image updating unit 223 determines whether the processing is the simple toner amount calculation. In a case of the simple toner amount calculation, by drawing the charge in red characters, it is possible to notify the user that the charge is a roughly calculated value and not calculated in detail.

Alternatively, the preview image updating unit 223 displays a message notifying the user of similar contents so that the user can understand whether the charge is calculated by the simple toner amount calculation or by the detailed toner amount calculation.

If the preview button 302 is pressed without changing the print setting, the preview display/update instruction reception unit 201 deletes the print data feature quantity relating to the print setting 224 to be previewed from the print setting record data 218, and performs normal preview display processing. By the operation, in step S402, the print setting reception unit 202 always goes to the sequence for performing the detailed toner amount calculation.

Depending on contents of a change of the print setting information, the processor 101 can determine whether an influence rate to an image formed in the RIP device 111 or the like due to the change of the print setting information is less than a threshold.

More specifically, if the change of the print setting information is a setting change from the color printing to the monochrome printing, the processor 101 determines that the influence rate is less than the threshold. That is, in such a case, the toner amount is calculated in the simple toner amount calculation unit 210.

If the change of the print setting information is a setting change from the monochrome printing to the color printing, the processor 101 determines that the influence rate is equal to or greater than the threshold. That is, in such a case, the toner amount is calculated in the detailed toner amount calculation unit 209.

Further, depending on the print data feature quantity calculated in the print data feature quantity calculation unit 206, and the contents of the change in the print setting information, the processor 101 can determine whether the influence rate to the image formed in the RIP device 111 or the like is less than the threshold.

More specifically, in a case where the change in the print setting information is a change in the setting relating to the image correction, the processor 101 determines as described below. That is, in a case where the print data feature quantity calculated in the print data feature quantity calculation unit 206 indicates that the ratio of the areas of the images is equal to or greater than a threshold in the print data, the processor 101 determines that the influence rate is equal to or greater than the threshold. That is, in such a case, the toner amount is calculated in the detailed toner amount calculation unit 209.

In a case where the print data feature quantity calculated in the print data feature quantity calculation unit 206 indicates that the ratio of the areas of the images is less than the threshold in the print data, the processor 101 determines that the influence rate is less than the threshold. That is, in such a case, the toner amount is calculated in the simple toner amount calculation unit 210.

In a case where the change in the print setting information is a change in the setting relating to the character black print, the processor 101 determines as described below. That is, in a case where the print data feature quantity calculated in the print data feature quantity calculation unit 206 indicates that the ratio of the areas of the texts is equal to or greater than a threshold in the print data, the processor 101 determines that the influence rate is equal to or greater than the threshold. That is, in such a case, the toner amount is calculated in the detailed toner amount calculation unit 209.

In a case where the print data feature quantity calculated in the print data feature quantity calculation unit 206 indicates that the ratio of the areas of the texts is less than the threshold in the print data, the processor 101 determines that the influence rate is less than the threshold. That is, in such a case, the toner amount is calculated in the simple toner amount calculation unit 210.

In a case where the change in the print setting information is a change in the setting relating to the toner application amount limitation, the processor 101 determines as described below. That is, in a case where the print data feature quantity calculated in the print data feature quantity calculation unit 206 indicates that the ratio of the areas of the graphics is equal to or greater than a threshold in the print data, and indicates that the number of pixels whose toner application amount is equal to or greater than a threshold is equal to or greater than a threshold, the processor 101 determines that the influence rate is equal to or greater than the threshold. That is, in such a case, the toner amount is calculated in the detailed toner amount calculation unit 209.

In a case where the print data feature quantity calculated in the print data feature quantity calculation unit 206 indicates that the ratio of the areas of the graphics is less than the threshold, or equal to or greater than the threshold in the print data, and indicates that the number of pixels whose toner application amount is equal to or greater than the threshold is less than the threshold, the processor 101 determines that the influence rate is less than the threshold. That is, in such a case, the toner amount is calculated in the simple toner amount calculation unit 210.

The exemplary embodiments of the present invention can be implemented by executing the following processing. That is, software (program) to implement the functions of the above-described exemplary embodiments is supplied to a system or apparatus via a network or various storage media. A computer (or central processing unit (CPU) or micro processing unit (MPU)) of the system or apparatus reads out and executes the program.

According to the above-described exemplary embodiments, in recalculating the toner amount, the number of generation of a full-size image from the print data can be reduced, and when the image is used on the preview screen, or the like, high responsivity can be achieved.

Especially, by separately using the settings of “color” and “monochrome”, the object types of “text”, “graphic”, and “image”, and the magnification rate as the feature quantities, to various parameter changes, the variations due to the setting change can be flexibly calculated.

Further, by using the frequency of the pixels to which the tonner of equal to or greater than the threshold is additionally applied as the feature quantity, with respect to whether to add a limitation to the toner application amount, the rasterization processing of each time can be prevented.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-228382 filed Oct. 8, 2010, which is hereby incorporated by reference herein in its entirety.

What is claimed is:

1. An image forming apparatus comprising:
a processor coupled to a memory, the processor configured to control:
a receiving unit configured to receive print setting information;
an image formation unit configured to perform image processing on print data, based on the print setting information received by the receiving unit, to form an image;
a print data feature quantity calculation unit configured to calculate a print data feature quantity of the print data based on the image formed by the image formation unit; and
a first toner amount calculation unit configured to calculate a toner amount in a case where the print setting information is changed, based on difference information between the print setting information before it is changed and after it is changed and the print data feature quantity calculated by the print data feature quantity calculation unit based on the image formed by the image formation unit using the print setting information before it is changed.

2. The image forming apparatus according to claim 1, wherein the processor is further configured to control:
a determination unit configured to determine whether an influence rate to the image formed by the image formation unit generated due to the change of the print setting information is less than a threshold in a case where the print setting information is changed,
wherein the first toner amount calculation unit calculates a toner amount based on the difference information and the print data feature quantity in a case where the determination unit determines that the influence rate to the image is less than the threshold.

3. The image forming apparatus according to claim 2,
wherein the image formation unit performs image processing on the print data based on the print setting information after the change and forms an image if the determination unit determines that the influence rate to the image is greater than or equal the threshold,
wherein the print data feature quantity calculation unit calculates a print data feature quantity of the print data based on the image formed by the image formation unit, and
wherein the processor is further configured to control a second toner amount calculation unit configured to calculate a toner amount based on the print data feature quantity calculated by the print data feature quantity calculation unit.

4. The image forming apparatus according to claim 3, wherein the processor is further configured to control:
a charge calculation unit configured to calculate a charge based on the toner amount calculated by the first toner amount calculation unit; and
a display unit configured to display the charge calculated by the charge calculation unit.

5. The image forming apparatus according to claim 4, wherein the charge calculation unit calculates the charge based on the toner amount calculated by the first toner amount calculation unit if the toner amount is calculated by the first toner amount calculation unit, calculates the charge based on the toner amount calculated by the second toner amount calculation unit if the toner amount is calculated by the second toner amount calculation unit, and the display unit displays the charge in such a manner that the charge to be displayed indicates whether the charge is calculated based on the toner amount calculated by the first toner amount calculation unit or the charge is calculated based on the toner amount calculated by the second toner amount calculation unit.

6. The image forming apparatus according to claim 2, wherein the determination unit determines whether the influence rate to the image formed by the image formation unit generated due to the change in the print setting information is less than the threshold using the content of the change in the print setting information received by the receiving unit.

7. The image forming apparatus according to claim 6, wherein the determination unit determines that the influence rate to the image formed by the image formation unit generated due to the change in the print setting information is less than the threshold if the change in the print setting information received by the receiving unit is a setting change from color printing to monochrome printing, and determines that the influence rate to the image formed by the image formation unit generated due to the change in the print setting information is greater than or equal to the threshold if the change in the print setting information received by the receiving unit is a setting change from monochrome printing to color printing.

8. The image forming apparatus according to claim 2, wherein the determination unit determines whether the influence rate to the image formed by the image formation unit generated due to the change in the print setting information is less than the threshold based on the print data feature quantity calculated by the print data feature quantity calculation unit and the content of the change in the print setting information received by the receiving unit.

9. The image forming apparatus according to claim 8, wherein the determination unit determines that the influence rate to the image formed by the image formation unit generated due to the change in the print setting information is greater than or equal to the threshold if the change in the print setting information received by the reception unit is a setting change relating to image correction, and the print data feature quantity calculated by the print data feature quantity calculation unit indicates that a ratio of an area of an image is greater than or equal to a threshold in the print data, and determines that the influence rate to the image formed by the image formation unit generated due to the change in the print setting information is less than the threshold if the print data feature quantity calculated by the print data feature quantity calculation unit indicates that the ratio of the area of the image is less than the threshold in the print data.

10. The image forming apparatus according to claim 8,
wherein the determination unit determines that the influence rate to the image formed by the image formation unit generated due to the change in the print setting information is greater than or equal to the threshold if the change in the print setting information received by the receiving unit is a setting change relating to character black print, and the print data feature quantity calculated by the print data feature quantity calculation unit indicates that a ratio of an area of a text is greater than or equal to a threshold in the print data, and determines that the influence rate to the image formed by the image formation unit generated due to the change in the print setting information is less than the threshold if the print data feature quantity calculated by the print data feature quantity calculation unit indicates that the ratio of the area of the text is less than the threshold in the print data.

11. The image forming apparatus according to claim 8, wherein the determination unit determines that the influence rate to the image formed by the image formation unit generated due to the change in the print setting information is greater than or equal to the threshold if the change in the print setting information received by the reception unit is a setting change relating to toner application amount limitation, the print data feature quantity calculated by the print data feature quantity calculation unit indicates that the ratio of an area of a graphic is greater than or equal to a threshold in the print data, and indicates that the number of pixels whose toner application amount is greater than or equal to a threshold is greater than or equal to a threshold in the print data, and determines that the influence rate to the image formed by the image formation unit generated due to the change in the print setting information is less than the threshold if the print data feature quantity calculated by the print data feature quantity calculation unit indicates that the ratio of the area of the graphic is less than the threshold or greater than or equal to the threshold in the print data, and indicates that a number of pixels whose toner application amount is greater than or equal to the threshold is less than the threshold in the print data.

12. A method for calculating toner amount, the method comprising:
receiving print setting information;
performing image processing to print data, based on the received print setting information, by forming an image;
calculating a print data feature quantity of the print data based on the formed image; and
calculating a toner amount if the print setting information is changed based on difference information between the print setting information before it is changed and after it is changed, and the calculated print data feature quantity based on the formed image based on the print setting information before it is changed.

13. A non-transitory computer-readable storage medium storing computer-executable instructions for causing a computer to implement a method, the method comprising:
receiving print setting information;
performing image processing to print data based on the received print setting information by forming an image;
calculating a print data feature quantity of the print data based on the formed image; and
calculating a toner amount if the print setting information is changed based on difference information between the print setting information before it is changed and after it is changed, and the calculated print data feature quantity based on the formed image based on the print setting information before it is changed.
